(19) United States
(12) Patent Application Publication
(10) Pub. No.: US 2013/0056887 A1
(43) Pub. Date: Mar. 7, 2013

(54) Device for purification of flue gas of industrial shredders

(71) Applicants: Erich Köhl, Meerbusch (DE); August van der Beek, Grevenbroich (DE)

(72) Inventors: Erich Köhl, Meerbusch (DE); August van der Beek, Grevenbroich (DE)

(73) Assignee: METSO LINDEMANN GMBH, Dusseldorf (DE)

(21) Appl. No.: 13/405,489

(22) Filed: Feb. 27, 2012

(30) Foreign Application Priority Data
May 11, 2011 (EP) 11 165 695.5

(51) Int. Cl. B01D 47/10

(52) U.S. Cl. 261/2; 261/76

(57) ABSTRACT

This invention relates to a device for purification of flue gas of industrial shredders.

This invention relates to a device for purification of flue gas of industrial shredders.

For the processing (conditioning) of residues such as discarded metal (metal scrap), big industrial shredders are used.

For environmental reasons, those shredders regularly include additional equipment to keep, for example, dust emissions, but also emissions by lipids, oils, fuels etc. as low as possible. The technical guide of practice “air” (German TA Luft) prescribes emission limits.

It has been tried to minimize harmful substances in the flue gas by a post burning process. Electric filters, biological filters and activated-carbon filters have also been adopted.

For shredders of the type mentioned, no technically and economically satisfying solution exists to this day.

This is not only true for solid, in particular fine components in the flue gas, but also for liquid or gaseous harmful substances, for example carbon hydrides (hydrocarbons).

DE 195 20 399 C2 relates to a method and an apparatus for the conditioning of sewage water from wet dust removing installations of industrial shredders. Thereby, the washing water of the wet dust removing installation is forwarded to a flotation installation. Solid deposits are collected in a downstream collection basin and dehydrated thereafter. The thus accumulated liquid is recycled to the wet dust removing installation, just like the flotation water of the flotation.

With the known installation, an important partial purification of the shredder flue gases is achieved. However, it is not capable of removing finest solid particles (particle size <1 μm, up into the nm range) as well as gaseous and liquid harmful substances from the washing water in an appropriate amount.

Therefore it is an object of the invention to provide a device for purification of flue gas of industrial shredders, which, compared to the state of the art, allows a higher degree of separation of harmful substances from flue gases. The term “shredders” also includes associated installations such as separators.

In doing so, the invention emanates from the technology disclosed in DE 195 20 399 C2 to forward the flue gas to a wet dust removing installation. There, the flue gas loaded with harmful substances is brought into contact with a washing liquid. The harmful substances are absorbed in the washing liquid, adsorbed and/or precipitated and mainly discharged with the washing liquid.

An important improvement of the inventive solution is to equip the wet dust removing installation with a multi-stage venturi washer, wherein the venturi stages are located one behind each other in the flow direction of the flue gas. Two venturi stages lead to limited installation requirements and a high cleaning/purification quality of the flue gas.

In its most general embodiment, the invention relates to a device for the purification of flue gas of industrial shredders with a wet dust removing installation for contacting the flue gas loaded with harmful substances with a washing liquid, wherein the wet dust removing installation comprises a venturi washer with multiple venturi stages arranged one behind the other in the flow direction of the flue gas.

One embodiment of the invention proposes to integrate an installation for pressurised dissolved air flotation into the device. In order to do so, the used washing liquid taken from the wet dust removing installation is forwarded to the pressurised dissolved air flotation and further processed there.

At the pressurised dissolved air flotation (Druckentspannungsflotation), this washing liquid gets saturated with air by over-pressure and is forwarded thereafter to a conventional flotation basin through expansion valves.

During processing of the washing water with a dissolved air flotation, carbon hydrides (hydrocarbons, VOCs) in all states of aggregation (solid, liquid, gaseous) can be bound, which further rise in the flotation basin by the finely divided air and accumulate as agglomerates in the surface area of the flotation liquid because of their low density, where they can be withdrawn afterwards by suction or removed.

For an optimisation of the pressurised dissolved air flotation a high air saturation of the washing water and the pressure water being essential. By an over-pressure of the pressure water of for example 3 to 8 bar and following pressure relief (decompression), a very fine gas-bubble spectrum can be achieved, whereby the agglomeration (adhesion) of air bubbles on the liquid and/or gaseous hydrocarbons improves.

It has been emphasised in extensive tests that carbon hydrides (carbon hydride compounds) in solid, liquid and gaseous phase can be removed this way from the washing liquid, wherein the separation efficiency can reach values up to 85% of the overall load of hydrocarbons and other harmful substances.

In between the wet dust removing installation and the pressurised dissolved air flotation, a sedimentation basin can be installed where the washing liquid is sent through to remove (further) solid harmful substances prior to the flotation stage.

Likewise, only a partial stream of the used washing liquid can be pumped straight from the wet dust removing installation to the pressurised dissolved air flotation, while another partial stream of the washing liquid (of the absorbent) is sent through/via the sedimentation basin.

The device can be optimised by different means which may be realised individually or in any combination (as far as these combinations are not explicitly excluded). Corresponding features are part of the description, the claims and the figures. Statements like “ahead, in front of, before”, “after” etc. relate to the normal, typical process, thus especially to the flow direction of the flue gas or the washing liquid respectively, if not stated any other.

The wet dust removing installation can be designed as follows:
With a first venturi stage, through which the flue gas of the shredder and/or of an associated separator (in which light and heavy materials are separated) is sent. At least one installation is arranged prior to the venturi stage (venturi-injector; venturi nozzle) and/or along the venturi stage to lead the washing liquid into the flue gas stream. The venturi stage can have one or more venturi grooves.
Behind the first venturi stage, a second venturi stage can be arranged. Both can be constructed equally.
The transverse section of each venturi stage is preferably adjustable to control the air speed. According to one embodiment the venturi groove of the second stage is smaller than the one of the first stage.
An alternative recommends to design at least one stage, for example the second stage, according to the teaching of DE 4331301 C2, thus with a displacer arranged behind the venturi groove, which can be mounted slidably. The supply of the washing liquid takes place in front of and/or along the venturi stage, centrally (in the central longitudinal direction to the flue gas stream) or from opposite sides of the venturi injector.
The washing liquid can be fresh water or flotation water from the pressurised dissolved air flotation.
A freshwater part increases the degree of efficiency of the separation and can compensate loss of liquid along the complete device simultaneously.
One embodiment recommends using flotation water in the first venturi stage and fresh water in the second venturi stage, partly or completely.
The washing liquid can be injected into the flue gas stream for example through/by injectors, sprinklers or other distributors. It is advantageous, when the liquid is injected into the wet dust removing installation by a spraying installation. By spraying the washing liquid, a high contact surface-area is achieved between the washing liquid and the flue gas and therefore a higher separation efficiency of harmful substances.
The mass ratio between the washing liquid of the first/second venturi stage is for example from 25:1 to 1:1 or 15:1 to 5:1
At least one flue gas pipe is arranged downstream of the wet cleaning stages, along which the clean/purified flue gas is extracted from the device, for example through a chimney into the atmosphere.
The used washing liquid, loaded with harmful substances, is forwarded from the wet dust removing installation into downstream parts of the device.

To send flotation water from pressurised dissolved air flotation back to the wet dust removing installation, at least one corresponding pipe is required. This is valid analogously for the supply of non used washing liquid to the wet dust removing installation.

Because of the optimised cleaning efficiency of the device of pressurised dissolved air flotation the flotation water is almost free of harmful substances when it is returned as (cleaned) washing water back to the wet dust removing installation.

By this means it is avoided that harmful substances concentrate because of circulation of the washing water and therefore lower the cleaning efficiency of the complete device, as this is frequently true in prior art devices.

In the device of pressurised dissolved air flotation an accumulation of separated harmful substances (for example carbon hydrides (hydrocarbons)) inevitably takes place in the area of the liquid surface, which can be treated in a post-cleaning process by further means.

By means of the device of pressurised dissolved air flotation it is achieved that solid, liquid and/or gaseous harmful substances accumulate in the surface area of the liquid in the flotation basin in form of agglomerate.

Accordingly, a further embodiment of the invention provides to equip the device of pressurised air flotation with a mechanical installation for the removal of this agglomerate. Such mechanical installations, for example screens, are known are therefore not explained here any further.

With respect to sediments mainly in the form of a slurry accumulating in the sedimentation basin and/or with respect to the device for pressurised dissolved air flotation corresponding installations for the removal of these sediments in the form of slurries may be provided. Further they can, especially after dehydration, either be dumped straight away or forwarded to post-processing steps.

Further characteristics of the invention derive from the characteristics of the subclaims and the other application documents.

The invention is further described hereafter. The attached drawing schematically displays a possible construction of the inventive device, namely in:

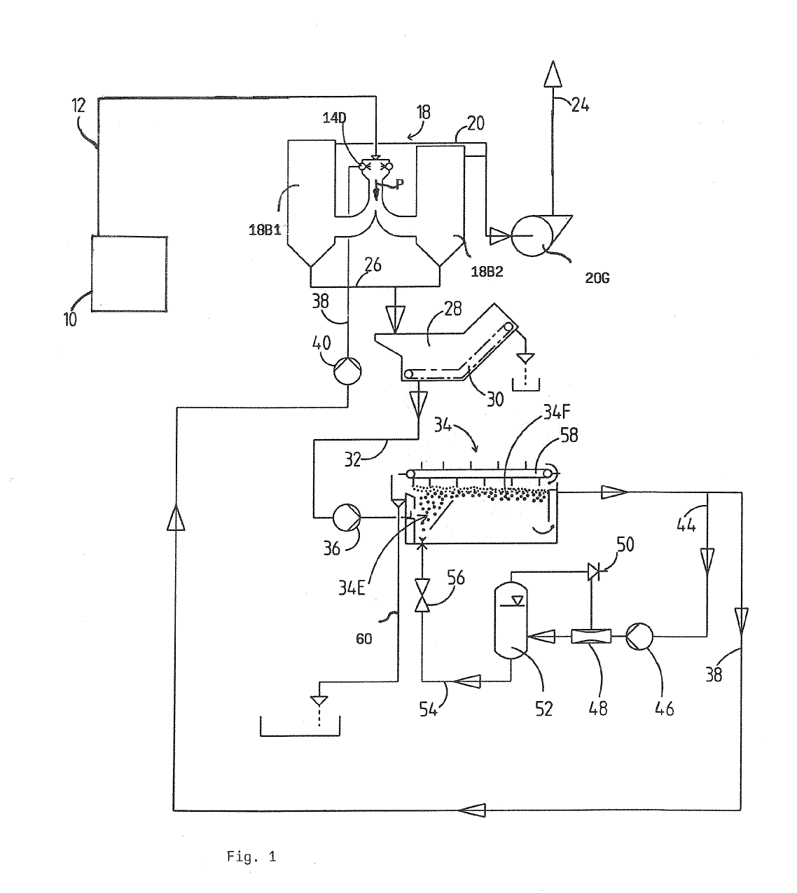

FIG. 1: an installation map of the complete device

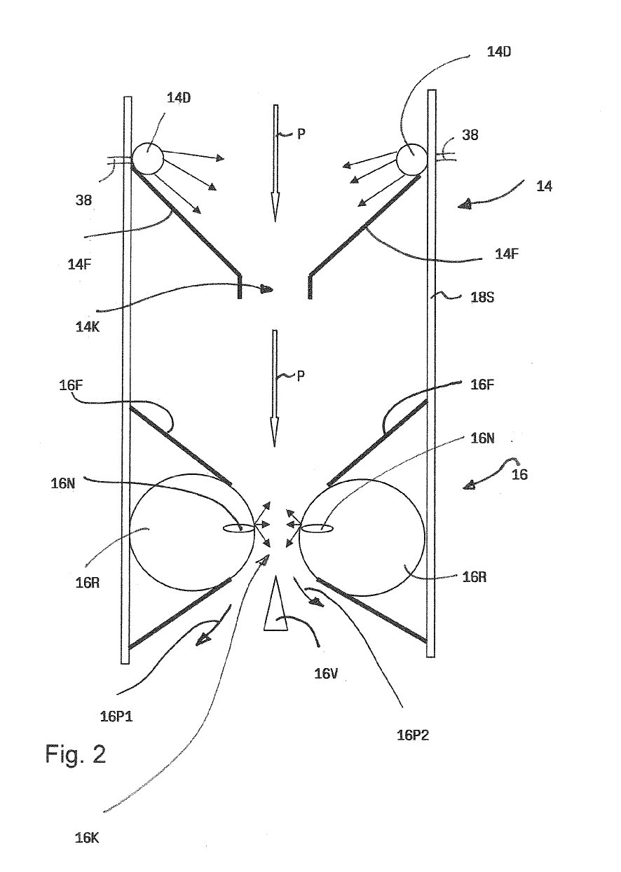

FIG. 2: one embodiment of a wet dust removing installation

Reference numeral 10 characterizes an industrial crushing device, in this case a shredder for discarded metal (metal scrap). From shredder 10, a flue gas pipe 12 extends to a wet dust removing device 18, which is designed as a two staged venturi cleaner. This part of the device 18 is displayed schematically in FIG. 2. The stream (flow) direction of the flue gas (top to bottom) is highlighted by arrows P.

The flue gas runs through a flow channel 18S comprising a first venturi stage 14 and a following second venturi stage 16.

The airstream is fed along the flow channel 18S by guiding plates 14F arranged in the first venturi stage 14 to a venturi groove 14K and accelerated in this process. In the displayed longitudinal section the guide plates 14F run conical towards each other. Via a pipe 38 and injectors 14D a washing liquid is injected into the flue gas stream in the form of small liquid droplets.

While passing through the first venturi stage (venturi injector) 14, the liquid drops are ripped apart (disrupted) due to the high air-stream speed, so that an aerosol like conditioning is achieved. The high acceleration of the flue gas along the venturi-injector 14 and the thus resulting high relative speed between the harmful substances in the flue gas and the washing liquid make sure that there is a first effective separation of impurities from the flue gas and adhesion to the washing liquid (also called absorbent).

The flue gas that was pre-purified this way is fed through the second venturi stage 16 afterwards. This venturi stage is designed slightly different to venturi stage 14. The area of the venturi groove 16K is arranged between two pipes 16R which run along opposite walls of the flow channel 18S. Through injector-like openings 16N in each pipe 16R, fresh washing liquid is injected into the flue gas stream. The flue gas is accelerated along guide plates 16F, similar to the guide plates 14F, on the way to said groove 16K and is divided into two partial streams behind said groove 16K by a displacer 16V (see arrows 16P1 and 16P2). By variation of the position of said displacer 16V, the corresponding gap widths and therefore the flow speed of the flue gas stream can be adjusted, before the flue gas streams enter into containers 18B1 and 18B2 arranged downstream. For the rest the process technology of the venturi stage 16 is equivalent to the one of the venturi stage 14. Through the post-purification in the second process stage 16 favorable purification efficiency is achieved for the flue gas.

While the purified flue gas is released by the aid of an air blower 20G through a pipe 20 from the upper end of the containers 18B1 and 18B2 to a chimney 24 and from thereon into the atmosphere, the used washing liquid is removed at the bottom of each container 18B1 and 18B2 and forwarded into a sedimentation basin. The sedimentation basin is facultative. The whole washing water can also be sent straight to an installation 34 for pressurised dissolved air flotation or (only) a partial stream of the washing water is sent along a bypass first into the sedimentation stage 28 and afterwards to the installation 34, which is further described in the following.

A sediment (slurry) formed in the sedimentation basin (settling tank) 28 is removed from the sedimentation basin 28 by a mechanical conveyor 30.

From the area of the sedimentation basin 28, in which the so far pre-cleaned washing liquid is stored, a liquid-pipe 32 runs to the entrance area 34E of the installation 34 for pressurised dissolved air flotation, whereby the transport of the liquid is done by a corresponding pump 36.

A pipe for flotation water is labelled 38 and leads away from the installation 34 opposite to the entrance area 34E and which leads, supported by a pump 40, the flotation water back to the wet dust removing installation 18, where the flotation water is injected into the flue gas via the injectors 14D (spraying installation).

A junction 44 runs from the pipe 38 to a water-pressure pump 46 followed by an ejector 48 into which a compressed air pipe 50 enters.

The flotation water flows from the ejector 48 into a pressurised water container 52 where it gets saturated with air. From there it flows through another compressed air pipe 54 to an expansion valve 56, from where the compressed air pipe 54 extends into the inlet chamber 34E of the installation 34. This inlet chamber 34E creates a contact and mixing zone between the supplied flotation water and the washing water from the sedimentation basin 28.

In the contact and mixing zone, the crucial further processing of the washing water takes place.

As a consequence of the pressure release to ambient pressure in the expansion valve 56, the previously dissolved air is released as small air bubbles. These smallest air bubbles (diameter in the μm range) are able to adhere on the solid, liquid and gaseous carbon hydrides (hydrocarbons) which still remain in the washing water after the pre-purification, and to bubble up with them.

Thereby, agglomerates of solid, liquid and gaseous impurities (including harmful substances) are formed, which are then forwarded from the contact and mixing zone into the downstream flotation zone 34F, where they mainly collect in the surface area as agglomerate.

This agglomerate is removed from the flotation basin by a mechanical installation (here: a flotation-slurry scraper 58) via a collection channel 60.

Particulate matter with a higher density than water sinks as sediments to the ground of the flotation installation 34 and can be removed there mechanically by a (not displayed) slurry scraper or sucked away, either continuously or discontinuously.

The remaining flotation water, now as far as possible freed from solid, liquid and gaseous impurities and harmful substances, is, as already explained, removed from the end of the installation 34 opposite to the contact and mixing zone, and sent back to the wet dust removing installation 18 via said flotation-water pipe 38.

The liquid used in the second venturi stage 16 may also contain flotation water, but there are advantages in the process to use at least partially fresh water or a fresh absorbent here.

This inventive device does not only allow an optimized removal of solid impurities (like dust) from the flue gas, but also a very extensive elimination of carbon hydrides (hydrocarbons), which could not be eliminated beforehand, and other liquid and gaseous harmful substances in the flue gas of the shredder. In doing so, purification efficiencies corresponding to those harmful substances of much more than 70% (for example 85%) have been achieved in pre-tests.

The device also includes an installation for drawing off (discharge) flue gas from the installation 34 for pressurised dissolved air flotation (not displayed).

The floating water may also be called flotation water. A wet dust removing installation is a wet dedusting installation/apparatus.

1. Device for the purification of flue gas of industrial shredders with a wet dust removing installation (18) for contacting the flue gas loaded with harmful substances with a washing liquid, wherein the wet dust removing installation (18) comprises a venturi washer with multiple venturi stages arranged one behind the other in the flow direction of the flue gas.

2. Device according to claim 1 comprising an installation (38,14D) located before and/or along the first venturi stage (14), to introduce the washing liquid into the flue gas stream.

3. Device according to claim 1, comprising at least one venturi stage featuring more than one venturi groove.

4. Device according to claim 1, wherein the transverse section of at least one venturi stage (14, 16) is adjustable.

5. Device according to claim 1, wherein the transverse section of the venturi groove of the second venturi stage (16) is smaller than the transverse section of the venturi groove of the first venturi stage (16).

6. Device according to claim 1, wherein at least one venturi stage (16) is equipped with a slidable displacer (16V) located behind the venturi groove (16K).

7. Device according to claim 1 comprising an installation (34) for pressurised dissolved air flotation and an apparatus (26) for the transport of used washing liquid from the wet dust removing installation (18) to the installation (34) for pressurised dissolved air flotation.

8. Device according to claim 7 with a liquid pipe (38) recycling flotation water as washing liquid from the installation (34) for pressurised air flotation back to the wet dust removing installation (18).

9. Device according to claim 1 with at least one spraying installation (14D, 16N) for injecting the washing liquid into the wet dust removing installation (18).

10. Device according to claim 9, wherein at least one spraying installation (14D, 16N) is located before to and/or along at least one venturi stage (14, 16) in such a way that the washing liquid is fed into the flue gas directly in front of and/or along the corresponding venturi stage (14, 16).

11. Device according to claim 7 wherein the installation (34) for pressurised dissolved air flotation comprises a mechanical apparatus (58) for removal of a floating agglomerate arranged on top of the washing liquid.

12. Device according to claim 7 with a sedimentation basin (28) being arranged, in flow direction, between the wet dust removing installation (18) and the installation (34) for pressurised dissolved air flotation.

13. Device according to claim 7 or 12, with at least one device (30) for a removal of slurry components from the sedimentation basin (28) and/or the installation (34) for pressurised dissolved air flotation.

14. Device according to claim 1 with an installation (20, 24) to discharge flue gas from the wet dust removing installation (18).

15. Device according to claim 1 with a freshwater supply (16N) to at least one venturi stage (16).
